(19) United States
(12) Patent Application Publication
(10) Pub. No.: US 2005/0284570 A1
(43) Pub. Date: Dec. 29, 2005

(54) Diagnostic plasma measurement device having patterned sensors and features

(76) Inventors: Daniel B. Doran, Fort Collins, CO (US); Leonard J. Mahoney, Fort Collins, CO (US); Steven J. Roberts, Severance, CO (US); Gregory A. Roche, Fort Collins, CO (US)

Correspondence Address: JOHN D. PIRNOT;ADVANCED ENERGY INDUSTRIES, INC., 1625 SHARP POINT DR., FORT COLLINS, CO, 80525, US

(21) Appl. No.: 10/875,954

(22) Filed: Jun. 24, 2004

(51) Int. Cl. C23F 1/00; G01L 21/30

(52) U.S. Cl. 156/345.24; 216/59

(57) ABSTRACT

A diagnostic plasma measurement device is provided having sensors and features disposed using pattern transfer fabrication techniques. A measurement device comprises a primary substrate with sensors for measuring plasma or surface properties disposed by a stepped pattern transfer technique, such as step-and-repeat photolithography, about the surface of the probe. Sensor fields include sensors that measure physical and electrical properties of a plasma, as well as sensors that measure properties of the wafer surface. Fields or components for processing electronics, electrical interconnections, memory, photovoltaic power, and wireless communication are also provided. By utilizing pattern transfer fabrication techniques, the invention generally provides for reduced risks of contamination of a plasma processing environment and increased manufacturability and reliability of the completed sensor device.

### BACKGROUND OF THE INVENTION

1. Field of the Invention

This invention relates generally to the field of plasma processing, and more particularly to devices for in-situ measurement of plasma properties within a plasma processing system.

2. Brief Description of the Prior Art

With recent developments in the technology of in-situ plasma metrology, it has become possible to obtain virtually noninvasive measurements of actual physical and electrical properties of a plasma within an operational plasma processing environment. For example, a wireless diagnostic plasma probe may comprise sensor devices disposed upon a substrate body that is comparable in physical structure and dimensions to a standard process workpiece, as for example a semiconductor wafer. An onboard power source may be provided, as well as electronic components for collecting, processing and storing data received from the sensors. A wireless communication interface receives and transmits the sensor data outside of the plasma processing environment for further processing and analysis. Further description of the operation and utility of exemplary plasma wafer probe devices is presented in U.S. Patent Application No. 10/194,526, assigned to the assignee of the present application.

Diagnostic plasma sensors may also be disposed at fixed locations within a plasma processing system itself. For example, plasma sensor devices may be disposed along a portion of the chamber liner of a vacuum processing system, about the dielectric isolation ring or gas injection ring of the chamber, or upon a portion of a substrate holder or “chuck.” In-situ sensor arrays may obtain diagnostic data, such as ion current flux and effective electron temperature, from multiple locations about the boundary of the plasma body for use in deducing the global or spatial properties of the plasma. Further description of the operation and utility of exemplary in-situ plasma sensor arrays is presented in U.S. patent application Ser. No. 10/640,892, owned by the assignee of the present application.

Sensors disposed upon a diagnostic plasma probe may include devices that measure thermal, optical, and electromagnetic properties of the process environment, and ideally include sensors such as dual floating Langmuir probes that can measure physical and electrical properties of the plasma itself without disturbing the properties being measured. In a typical diagnostic probe, sensors may be modular sub-components mounted onto a discrete circuit substrate such as a ceramic or high temperature thermal plastic. Sensor modules are then bonded to the surface of the wafer probe using, for example, a stress relieving adhesive. Alternatively, sensors may be fashioned as diced chips and bonded to the base wafer using flip-chip bonding techniques. U.S. Pat. No. 5,444,637 describes a programmable semiconductor wafer having sensors formed lithographically upon the wafer substrate.

Output leads of sensors may be connected by wirebond or similar technique to conductive interconnection paths between the sensors and the onboard processing electronics and power source of the wafer probe. Electrical interconnection paths may be formed using silver paint or a silk-screened conductive paste, for example, or alternatively by patterning techniques used in the manufacture of integrated circuits. Materials used in the construction of sensors and sensor modules, as well as those used for adhering and electrically bonding sensors to the probe surface, must all be compatible with and tolerant of the processing environment such that the use of the plasma probe does not result in either physical or chemical contamination of the processing chamber, or of material subsequently processed in the processing chamber.

For diagnostic plasma measurement probes to be cost effective for high-volume commercial applications, such as in the manufacture of semiconductor devices, it should be possible to mass produce probes for use in large quantities as consumable articles. To this end, a diagnostic probe having a simplified and standardized design with minimal part count would be advantageous. It would be further desireable to utilize manufacturing techniques having reduced risks of product contamination. It would be further desirable to provide enhanced flexibility in customizing or modifying the elements and interconnections of a diagnostic probe for differing applications.

### SUMMARY OF THE INVENTION

This invention provides a diagnostic plasma measurement device having sensors and features disposed using pattern transfer fabrication techniques. A measurement device of the invention generally comprises a primary substrate with sensors for measuring plasma or surface properties disposed by stepped pattern transfer about the surface of the probe. Electrical interconnections are provided between the sensors and power, communications, and processing and control elements of the measurement device.

In one embodiment of the invention, a diagnostic plasma probe comprises a plurality of sensor fields patterned upon a silicon wafer substrate using step-and-repeat photolithography. Sensor fields include sensors that measure physical and electrical properties of a plasma, as well as sensors that measure properties of the wafer surface. In a preferred embodiment, multiple sensor types are combined into a single field that is patterned repeatedly across the wafer surface. The wafer-based probe is introduced into a plasma processing environment and the sensors and processing electronics of the probe are activated to collect data relating to surface or plasma properties. The probe is fitted with an on-board wireless transceiver system for communication of data and instructions with a base station transceiver outside the plasma processing system.

Embodiments of the invention include integrated diode temperature sensors disposed by pattern transfer upon a substrate of a diagnostic plasma probe device. Embodiments of the invention also include plasma property sensors such as dual floating Langmuir probes disposed by pattern transfer for measurement of ion current flux and apparent electron temperature of the plasma. Additional plasma or substrate sensors disposed by pattern transfer in accordance with the invention include electrostatic charge sensors, optical emission and photo sensors, surface acoustic wave sensors for measuring pressure, film thickness and deposition rates, and the like. In certain embodiments of the invention, sensor pads are protected from the corrosive plasma environment with plugs of corrosion resistant conductive materials applied using for example a damascene process.

The invention also features electrical interconnections disposed by pattern transfer techniques. In one embodiment of the invention, electrical interconnection fields in addition to sensor fields are disposed by pattern transfer upon the substrate of a wafer-based plasma probe. Electrical interconnection fields comprise conductive pathways for electrical connection of sensor fields to probe electronics and power source. By employing field stitching techniques in the lithographic processes used to create the sensor and interconnection fields, the conductive pathways overlap and electrically connect to interconnection leads of the sensor fields, or to the conductive pathways of other interconnection fields. By creating electrical interconnections as well as sensors of a plasma probe device by pattern transfer techniques, manufacture of the probe device may largely be performed on any modern integrated circuit (IC) production line, and may be modified to suit the requirements of particular applications or users.

In another embodiment, electrical interconnections on a diagnostic probe device are provided by an overlayed wafer-level interconnection field. In one example, the interconnection field is disposed using wafer-level pattern transfer operations upon a wafer having sensor fields previously disposed by step-and-repeat photolithography. The interconnection field comprises conductive pathways for electrical connection of interconnection leads of the sensor fields to electronics and power source of the probe. In a preferred embodiment, the wafer-level lithographic operations also provide elements of additional plasma or surface sensors. In this approach, the advantages of mass production of die in a traditional IC manufacturing environment are combined with the simplicity and selectivity of wafer-scale pattern transfer techniques.

Further embodiments of the invention comprise photovoltaic power elements disposed by pattern transfer techniques. The photovoltaic power elements collect and convert radiant energy to electrical energy for use by sensors and electronics of a diagnostic probe device. Photovoltaic elements may be optimized for conversion of ambient light for recharging an onboard energy reservoir of the probe, or of plasma radiance for supplementing the power demands of the sensors and electronics of the probe during their operation. Use of photovoltaic power fields can lessen reliance upon a modular power source such as a battery adhered onto the substrate surface. As a result, the height, weight, and center of mass of an in-situ plasma probe can be better optimized for compatibility with multiple plasma processing platforms.

In accordance with further embodiments of the invention, logic, processing, communications, and other electronic components and circuitry of a plasma probe device are disposed by pattern transfer techniques. By patterning electronics of the probe in proximity to sensor fields, noise and power loss in the circuits may be substantially reduced. Disposition of these additional features by pattern transfer operations also improves flexibility and reliability of the design while further reducing part counts, size and cost.

The invention includes wafer-based probe devices in which integrated sensing, processing, and wireless communication fields operate as parts of a wafer-based local area network (LAN). In other embodiments, sensor system fields disposed upon a wafer substrate are diced into sensor chips for fixed placement within a plasma processing system. In this way, for example, sensor and circuit designs may be used for both wafer-based as well as fixed, in-situ diagnostic probes while reducing die cost through economies of scale.

By utilizing semiconductor fabrications techniques, the invention generally provides reduced risk of contamination by residues of manufacturing steps not maintained at cleanliness level dictated by the IC industry. Use of stepped pattern transfer techniques serves also to reduce part count, simplify fabrication and increase function and reliability of the completed sensor device. A sensor probe design may thus be optimized for cost effective production techniques while ensuring mechanical, chemical, and thermal compatibility with the wafer or other carrying substrate and the environment to which it is exposed.

Diagnostic probes of the invention are ideally suited for measuring in-situ plasma properties in semiconductor fabrication processes. Devices and technology of the invention are also suitable for use in other plasma applications and process environments. For example, embodiments may be employed in the production of flat panel displays, architectural glass, storage media, and the like. Substrates comprising technology of the invention may include but are not limited to all semiconductor substrates (silicon, gallium arsenide, germanium or others), as well as micro machine substrates, quartz, Pyrex and polymeric substrates.

### BRIEF DESCRIPTION OF THE DRAWINGS

FIG. 1 illustrates an example of a plasma processing system in which sensor probes of the invention may be utilized.

FIG. 2 illustrates a wafer-based plasma probe comprising sensors and other features disposed in accordance with one embodiment of the invention.

FIG. 3 illustrates an integrated temperature diode sensor in accordance with one embodiment of the invention.

FIG. 4 illustrates dual floating Langmuir probe sensor in accordance with one embodiment of the invention.

FIG. 5 illustrates a wafer-based plasma probe comprising sensors, interconnections, and other features disposed in accordance with one embodiment of the invention.

FIGS. 6a and 6b illustrate a wafer-based plasma probe comprising sensors, interconnections, and other features disposed in accordance with another embodiment of the invention.

FIG. 7 illustrates a wafer-based plasma probe comprising sensors, photovoltaic power cells, and other features disposed in accordance with one embodiment of the invention.

FIG. 8 illustrates a wafer-based plasma probe comprising sensors, photovoltaic power cells, and other features disposed in accordance with another embodiment of the invention.

FIG. 9 illustrates a wafer-based plasma probe comprising sensor system fields and other features disposed in accordance with one embodiment of the invention.

FIG. 10 illustrates a wafer-based plasma probe comprising sensor system fields and other features disposed in accordance with another embodiment of the invention.

FIG. 11 illustrates a further example of a plasma processing system in which sensor probes of the invention may be utilized.

FIG. 12 illustrates the use of sensor system chips in a sensor array in accordance with an embodiment of the invention.

### DETAILED DESCRIPTION

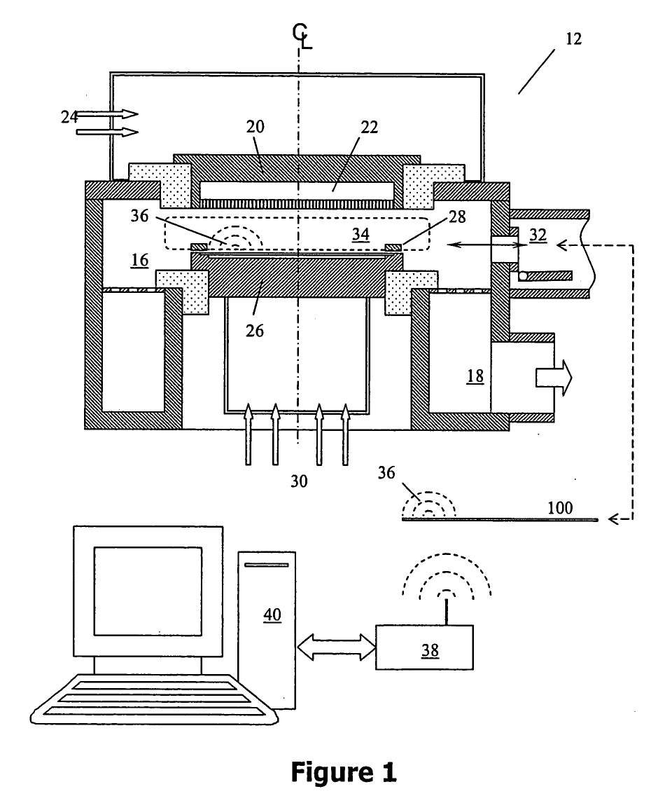

FIG. 1 illustrates one example of a plasma processing system in which sensor probes of the invention may be utilized. The plasma processing system 12 comprises a vacuum processing chamber 16, a pumping manifold 18, a plasma source electrode 20 mounted to the top of the chamber, a gas delivery manifold or gas shroud 22, gas flow and power connections 24 to the plasma source electrode 20, a wafer chuck 26 with clamp ring 28 or provision for electrostatic clamping, RF power, fluid coolant, lifting pin, and helium backside-cooling services to the chuck 30, and a load lock transfer stage with mechanical robotics 32 to manipulate wafers into the chamber 16 and onto the chuck 26. A diagnostic probe 100 is comprised of a silicon wafer substrate that incorporates plasma sensor diagnostic circuitry, wireless communications and a stored power system. Preferably, the sensors are fabricated onto a semiconductor wafer such as a 200 mm or 300 mm diameter silicon wafer. Alternatively, the sensors may be fabricated onto any process work piece such as a ceramic, plastic, metal or glass work piece surface that can be introduced into the vacuum chamber. The probes are fabricated such that normal wafer transfer mechanics and robotics are utilized to move the probe wafers into and out of the plasma processing environment.

Plasma 34 is ignited to perform an etching, stripping, or deposition process on the surface of the wafer, at which time the apparatus sensors and microprocessor are activated or triggered to collect data relating to surface or plasma properties in close proximity to the apparatus surface in real time. An on-board wireless transceiver system 36 is used to communicate data and instructions with a base station transceiver 38 outside the plasma processing system. The base station transceiver 38 allows for communication of data and instructions between the software of the external computer 40 and the probe 100 in real time. Alternatively, it is possible to have the probe collect information inside the process and then download data once it is removed from the process chamber.

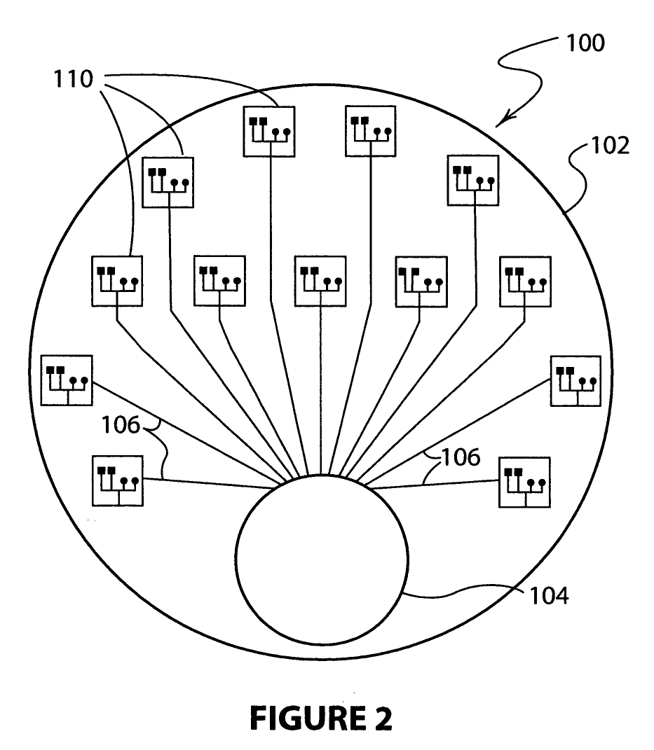

FIG. 2 illustrates a wafer-based plasma probe in accordance with one embodiment of the invention. Sensor probe 100 comprises a 200 mm or 300 mm silicon wafer primary substrate 102 having physical and electrical properties standard to typical semiconductor starting material. Probe 100 further comprises sensors 110 for measurement of plasma or surface properties. An electronics module 104 comprising onboard power, communications, and information processing and storage components of probe 100 is disposed upon the surface of probe substrate 102. Electronics module 104 ay be provided as a prepackaged and sealed unit as described for example in U.S. patent application Ser. No. 10/815,124, owned by the assignee of the present application. Conductive interconnections 106 are disposed upon substrate 102 for electrical interconnection of sensors 110 to electronics module 104 and electrical components therein. A dielectric surface passivation layer (not shown) is disposed upon the wafer surface for physical protection and electrical isolation of conductive interconnections 106.

In accordance with the present invention, sensors 110 are disposed by stepped pattern transfer upon substrate 102. In one approach, images corresponding to the features of sensor fields are contained within sets of photolithographic masks. A photomask is mounted upon an imaging reticle, and the image of the mask is exposed onto a photoresist layer sequentially across the wafer surface using for example a step-and-repeat or step-and-scan projection printing technique. The photoresist is developed, leaving resist patterns that define and limit areas affected by subsequent etching, implantation, or other operations performed upon the wafer. The image of a succeeding photomask of the mask set is exposed upon a subsequently applied photoresist layer so as to overlay the preceding image, followed by additional feature-building operations upon the wafer. This sequential layering process continues until the fabrication of all features of the sensor fields is complete. While use of a photolithographic technique is described in connection with the present embodiment, other techniques such as soft lithography, ink jet lithography, or other forms of “direct write” lithography may be employed for pattern transfer of sensors and features of the invention.

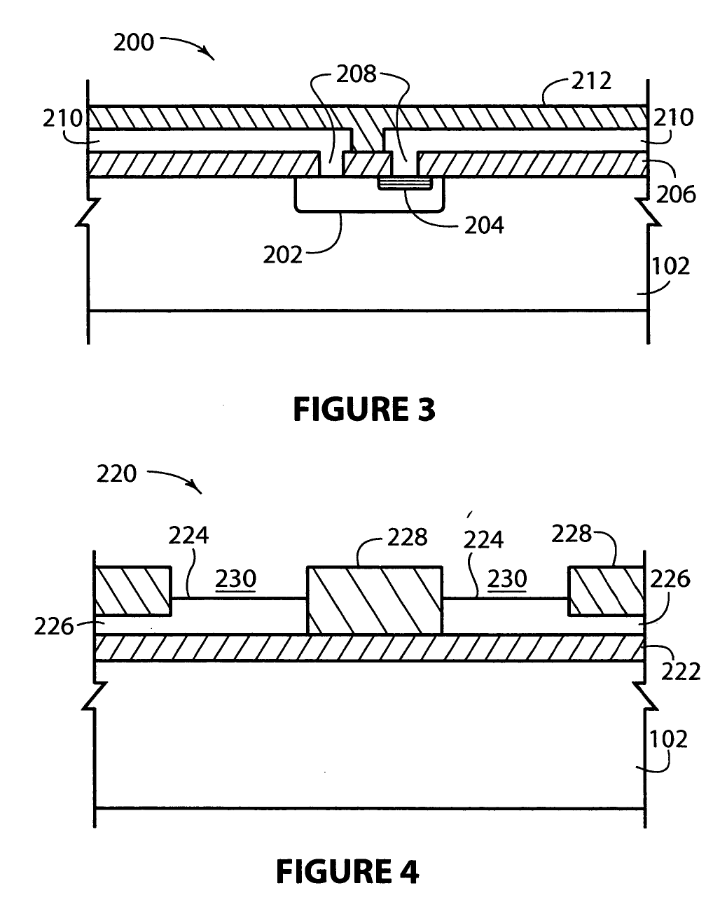

FIG. 3 illustrates an integrated diode temperature sensor disposed by pattern transfer upon substrate 102 according to one embodiment of the invention. Diode temperature sensor 200 comprises n-type well 202 together with p-type well 204 created within silicon probe substrate 102. Wells 202 and 204 may be created using techniques well known in the manufacture of semiconductor devices, as for example by successive application and exposure of photoresist layers through lithographic masks, followed by doping or ion implantation and diffusion to create the desired n-type or p-type regions. In a preferred embodiment, n-type well 202 occupies an area of approximately 10 μm by 10 μm, while p-type well 204, embedded within n-type well 202, occupies an area of approximately 5 μm by 8 μm. A dielectric layer 206 is disposed upon substrate 102 with contact holes 208 created by further photolithographic and contact etch operations. A conductor, such as aluminum, is blanket deposited and etched to form electrical interconnection leads 210 in contact with n-type well 202 and p-type well 204. A surface passivation layer 212, comprised for example of a dielectric metal oxide, nitride, or oxynitride, is provided for physical protection and electrical isolation of electrical interconnections from the plasma environment.

To obtain a temperature measurement, two unique scaled currents I₁ and I₂ from the probe controller sequentially bias the temperature diode. The two resulting forward diode voltages are measured and subtracted by the controller to create a difference voltage ΔV_{f}. The difference voltage represents an accurate, process independent relationship to absolute wafer temperature T according to the relationship:
T=ΔV_{f}* q/[k*ln(I₂/I₁)]
where q is electron charge and k is the Boltzmann constant. Calibration of the bias current ratio at the controller is required to insure the accuracy of the overall temperature sense function. In a preferred embodiment of the invention, a diode current ratio of 10:1 (for example, I₁=5 μA and I₂=50 μA) results in a difference voltage of 59.6 mV when the diode is at 27° C. Other diode current ratios can be selected in order to increase the measured difference voltage at the temperature diode such as might be necessary to optimize the resolution of a measured wafer temperature, as well as to reduce signal-to-noise in the related A/D measurement circuitry.

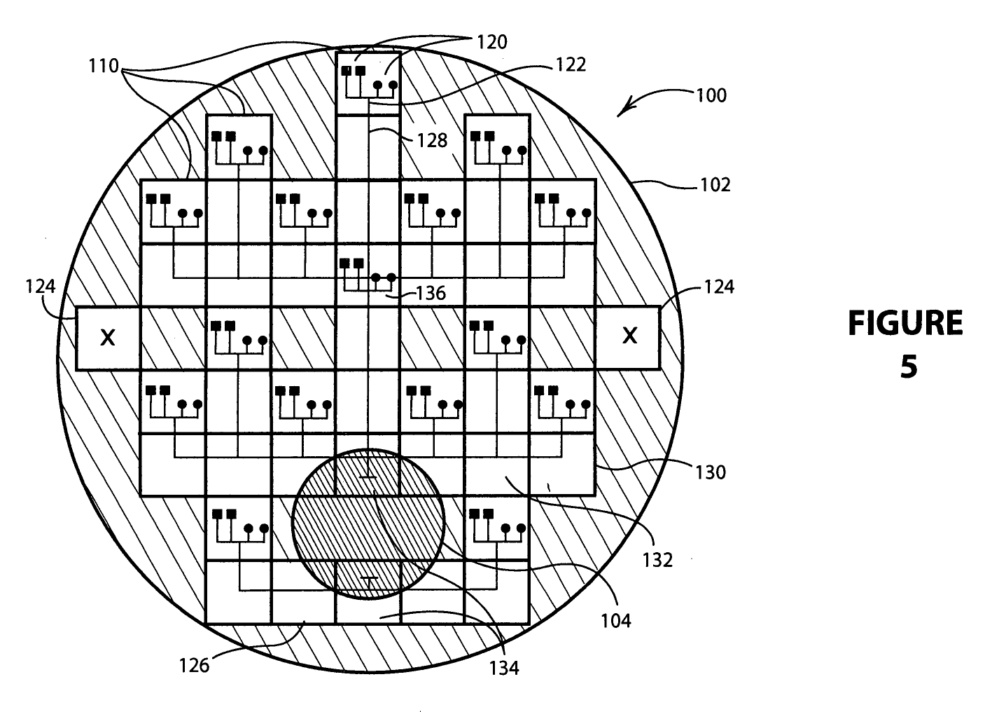

FIG. 4 illustrates a dual floating Langmuir probe (DFP) plasma sensor disposed by pattern transfer upon substrate 102 in accordance with another embodiment of the invention. The operation of DFP sensors generally is described for example in U.S. patent application Ser. No. 10/194,526. DFP sensor 220 comprises conductive pads 224 interconnected to remote biasing and measurement circuitry. A dielectric layer 222 disposed upon silicon substrate 102 insulates conductive pads 224 from the substrate. Aluminum is blanket deposited and pattern etched to form conductive pads 224 and electrical interconnection leads 226 Surface passivation 228 is applied, with recesses 230 created through masking and etching operations in order to expose conductive pads 224 to the plasma environment for measurement of ion current flux and apparent electron temperature of the plasma.

In alternative embodiments of the invention, recesses created in an outer passivation layer, such as those depicted in the foregoing embodiment, are filled with plugs of corrosion resistant conductive materials. For some processing applications, the aluminum conductive pads of a sensor are quickly eroded by the application chemistries, as for example in metal or polysilicon etch operations using chlorine, bromine boron tri-chloride, or other corrosive gases. A variety of metals, including tungsten, palladium, platinum, molybdenum, and nickel, have significantly greater resistance to these corrosive chemistries. After forming a recess to expose a sensor pad, such as the recesses 230 shown in FIG. 4, a corrosion resistant metal is deposited over the wafer surface. The wafer surface is then polished, using for example a chemical-mechanical polishing process, until the metal is removed from the outer insulating passivation layer. Plugs of the desired corrosion resistant metal remain in the recess areas, however, which protect the aluminum sensor pads from the corrosive plasma environment.

In a preferred embodiment of the invention, an integrated sensor field combines a diode temperature sensor, a DFP sensor, and an electrostatic charge sensor within the field. The integrated sensor field is replicated across the surface of a wafer diagnostic probe using a step-and-repeat pattern transfer technique. Electrical interconnections are provided between some or all of the sensors of the repeated integrated sensor fields and the electronics and power source of the probe.

Sensor probes of the invention may comprise sensors of any type and number as may be desired to provide spatial and temporal characterization of various plasma or substrate properties, as described for example in U.S. application Ser. Nos. 10/194,526 and 10/640,892. Additional plasma or substrate sensors that may be disposed by pattern transfer in accordance with the invention include electrostatic charge sensors, optical emission and photo sensors, surface acoustic wave sensors for measuring pressure, film thickness and deposition rates, and the like. A diagnostic sensor probe in accordance with the invention may include additional sensors disposed by any means.

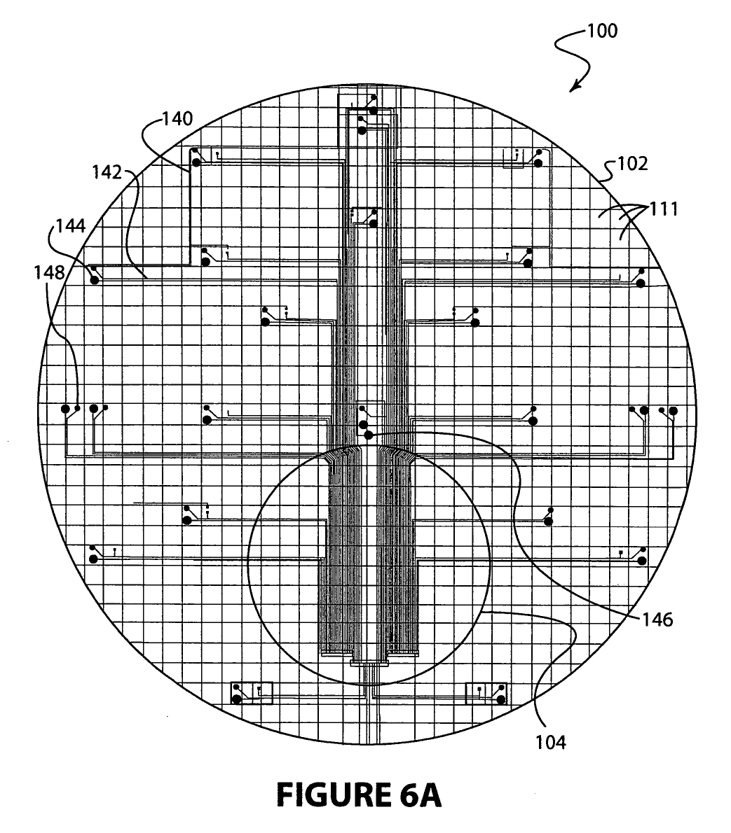

FIG. 5 illustrates an embodiment of the invention in which electrical interconnections, as well as sensors, are disposed by pattern transfer upon the surface of a diagnostic plasma probe. Sensor probe 100 comprises sensor fields 110 disposed by stepped pattern transfer upon the probe substrate 102. In this embodiment, each of sensor fields 110 comprises sensors 120 together with associated electrical interconnection leads 122 for electrical connection of the sensors to an onboard power source and electronics of the wafer probe. Sensors 120 of sensor fields 110 are of multiple types, including for example both an intergrated temperature diode and a dual floating Langmuir probe. Using step-and-repeat lithography, each of identical sensor fields 110 is patterned onto the surface of substrate 102. In other embodiments, sensor fields are not identical, but instead comprise different sensor types deployed in a desired configuration across the wafer surface. Thus, for example, one alternative embodiment of the invention comprises a temperature diode sensor field and a complementary DFP sensor field that are patterned alternately across the surface of the wafer probe substrate. Fiducial fields 124 serve as a a reference or alignment mark during the lithographic operations for transfer of other field patterns to the wafer surface. As will be readily appreciated, the lithographic transfer of sensor fields of the invention may involve many individual process steps, including a sequence of step-and-repeat or step-and-scan exposures with different pattern masks, before the pattern transfer operation is complete.

Referring again to FIG. 5, electrical interconnection fields are also disposed by pattern transfer upon probe substrate 102. Electrical interconnection fields comprise conductive pathways for electrical connection of electrical interconnection leads 122 of sensor fields 110 to probe electronics and power source. As depicted in FIG. 5 interconnection fields may include horizontal 126 and vertical 128 routing fields, “L” 130 and “T” 132 routing fields, as well as fields providing electrical attachment points 134 corresponding to terminals of an electronics module (not shown). A consolidated field 136 comprises both sensors 120 and conductive pathways. Electrical interconnection fields are disposed as needed among sensor fields to create a wafer-level electrical interconnection pattern. By employing field stitching techniques in the lithographic processes used to create the sensor and interconnection fields, the conductive pathways of interconnection fields overlap and thereby are electrically connected to interconnection leads 122 of sensor fields and/or conductive pathways of other interconnection fields. As a result, the stitched fields disposed upon the wafer probe surface form a wafer-level electrical interconnection pattern that connects sensors of the probe to the probe electronics and power source.

By creating electrical interconnections as well as sensors of a plasma probe device by pattern transfer techniques, manufacture of the probe device may largely be performed on any modem integrated circuit (IC) production line. Manufacturing the probe device in an IC fabrication facility can result in significant production efficiencies and cost savings, as well as reduced risks of contamination from equipment or processes not maintained at the cleanliness level dictated by the IC industry. The approach also provides flexibility in that individual pattern modules may be modified or added without the need to remake the entire mask set for the product. The patterning of routing and interconnect fields may also be modified to suit the requirements of particular applications or users, improving utility and reducing the costs of customization. “Open” fields, or those having electrical attachment points, provide further flexibility for add-on components, such as remote power modules, third-party sensors, or other electronics.

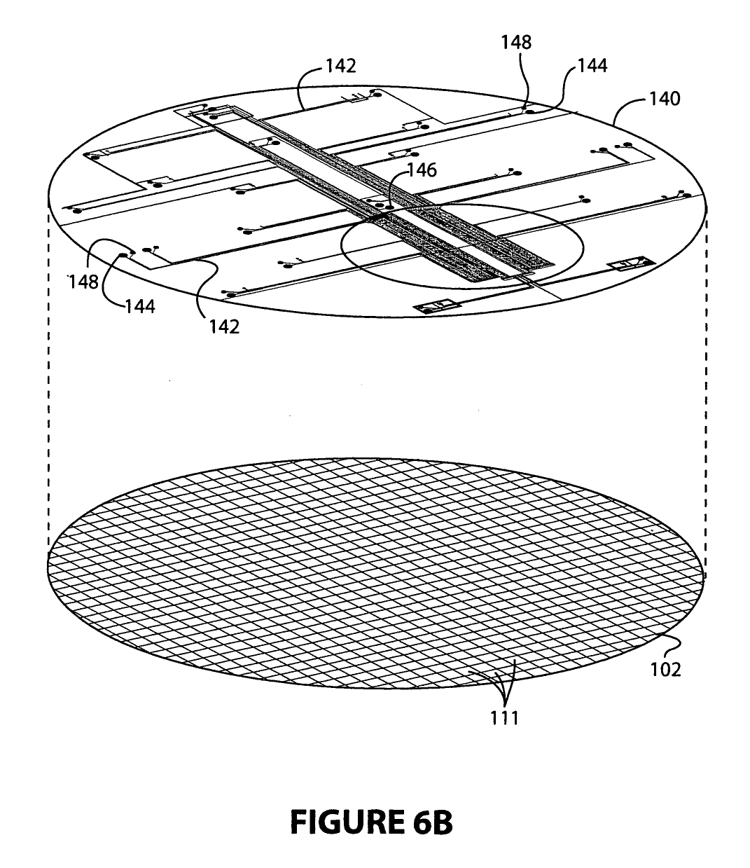

FIGS. 6a and 6b illustrate an alternative embodiment of the invention having sensors and interconnections disposed by hybrid pattern transfer techniques. Diagnostic probe 100 comprises temperature diode sensor fields 111 disposed across substantially the entire surface of probe substrate 102 by step-and-repeat photolithography. Each sensor field 111 comprises an integrated temperature diode sensor such as that described in connection with the embodiment illustrated in FIG. 3, with associated electrical interconnection leads. Stepper field masks are created to define the pattern and circuits of sensor fields 111, and the reticle masks are stepped across the surface of wafer substrate 102 incrementally to place the sensors.

Electrical interconnections are disposed upon probe substrate 102 by overlayed interconnection field 140. In a preferred embodiment, interconnection field 140 is disposed using wafer-level photolithographic pattern transfer operations upon a wafer having temperature diode sensor fields 111, or other sensor fields, previously disposed thereupon. Interconnection field 140 comprises conductive pathways 142 for electrical connection of electrical interconnection leads of sensor fields 111 to electronics and power source of probe 100. Alignment marks are provided in interconnection field 140 for alignment of the wafer-level interconnection field mask to the underlying sensor circuits and interconnection leads. Additional alignment marks are also provided in sensor fields 111 to define module-to-module locations and layer-to-layer placement during stepper exposure operations.

Interconnection field 140 further comprises elements of additional sensors for measurement of plasma or substrate properties. Interconnection field 140 further comprises a plurality of DFP sensor pads 144 and a plurality of differential voltage probe pads 148. Circular DFP sensor pads 144 are metallic disks approximately 1.5 mm in diameter. Common DFP pad 146 serves as a collection pad for each of DFP pads 144, such that each of DFP pads 144 and common pad 146 operates as a DPF sensor that senses electrical properties of the plasma as between each of DFP pads 144 and common pad 146. Metallic DFP pads 144 are disposed so as to shield underlying temperature sensor diodes from ultraviolet radiation emitted from the plasma that would otherwise degrade performance of the diodes. Charge sensors 148 for measurement of electrostatic field patterns across the wafer surface are disposed as metallic pads adjacent to DFP pads 144. A sensor ground reference is provided as a ground bus (not shown) routed about the edge of interconnection field 140.

While retaining the advantages of manufacturing the probe device on modern IC production lines, use of hybrid pattern transfer techniques results in additional advantages. A variety of sensor technologies may be incorporated into a sensor field that is patterned economically in large numbers across substantially the entire surface of a probe substrate. With the sensor fields already thus disposed, an interconnection field may be designed and disposed in a separate lithographic process that selectively interconnects any or virtually all of the sensors to the electronics and power source of the probe device. In certain embodiments of the invention, the overlayed interconnection field comprises common power, ground bus, and control lines to which any or all of the previously patterned sensors may be interconnected. The wafer probe architecture and functionality may thus be tailored to different processes, tools, and user preferences, providing adaptibility and flexibility. To add or remove sensors, the interconnection pattern of the probe may be updated without having to modify the entire sensor mask set. Alternatively, sensor fields may be improved or updated while retaining the same wafer-level interconnection pattern.

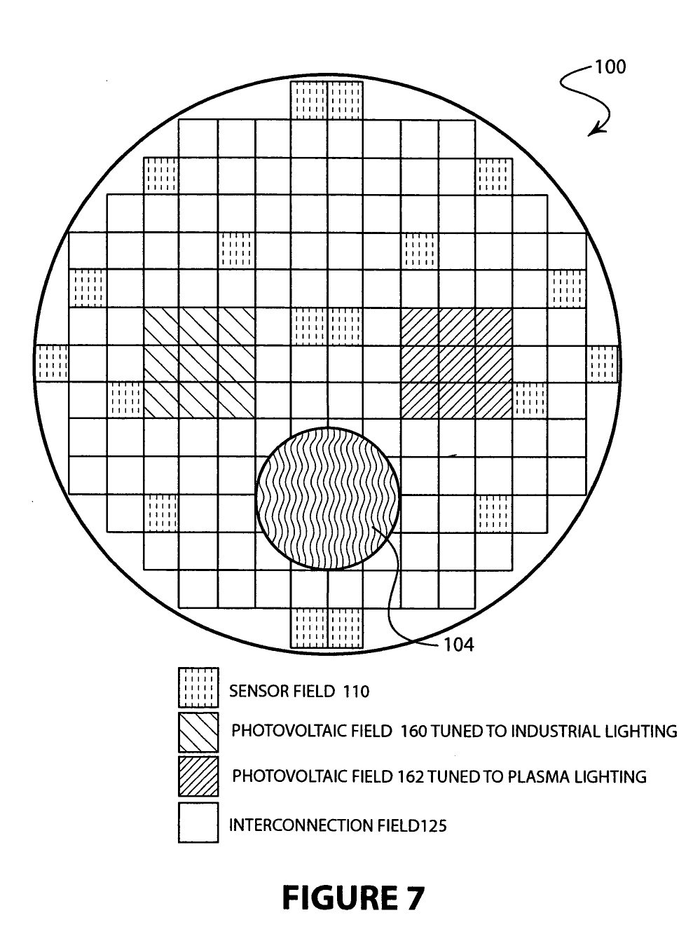

FIG. 7 illustrates a wafer-based diagnostic probe having sensors and photovoltaic power elements disposed by pattern transfer techniques in accordance with another embodiment of the invention. Diagnostic probe 100 comprises sensor fields 110 disposed by stepped pattern transfer techniques and interconnections 125 as exemplified in embodiments of the invention heretofore described. Diagnostic probe 100 further comprises photovoltaic power fields 160, 162 patterned by step-and-repeat lithography processes upon the surface of the probe substrate. Each of photovoltaic power fields 160 and 162 comprise at least one photovoltaic cell that collects and distributes photovoltaic energy to sensors and electronic subsystems of probe 100

An exemplary photovoltaic cell comprises a shallow p-n junction formed using standard IC manufacturing techniques upon the surface of wafer probe 100, and which converts incident photons to photoelectric power. A basic discussion of the physics and operation of photovoltaic devices appears in Sze, Physics of Semiconductor Devices, pp. 790-838 (1981). A photo-transparent protective overcoat (not shown), such as SiO₂ or a polyimide resist material, is disposed to protect the photovoltaic cells from the plasma environment. A DC-DC regulator with associated current switching electronics is provided adjacent to each photoelectric cell for filtering and regulation of power generated by photocells to voltage and current levels required by probe sensors and electronics. Photoelectric cells are optimized for power conversion of either ambient lighting or photo emission from the plasma. By way of example, energy conversion efficiency of a photoelectric cell may be optimized for a given spectral irradiance by engineering the device band-gap characteristics of the device or by incorporating a multi-layer, thin-film anti-reflection coating which improves transmission of various spectra to the active junction of the photoelectric cell(s). Referring to FIG. 7, photocell of power field 160 is optimized for collection of photoelectric energy from typical ambient industrial lighting. In this way, energy collected while the probe is stored in ambient light conditions may be used to recharge a battery or other onboard energy reservoir of the probe. Photocell of power field 162 optimized to the spectral irradiance generated by plasmas normally imposed upon the wafer probe. When the probe is deployed into a plasma processing environment, energy collected from the photocell of field 162 draws upon the photo emission of the plasma to supplement the power demands of the sensors and electronics of the probe during their operation.

As illustrated in FIG. 7, photovoltaic power fields are disposed upon the wafer surface as groups or arrays of photoelectric power cell dies using step-and-repeat lithographic techniques, with the number and size of photocells chosen to provide a desired voltage or power output. In alternative embodiments, photovoltaic cells are disposed upon the surface of discrete elements bonded to the wafer surface, such as upon the probe electronics module. Power derived from photovoltaic cells is provided to central electronics or a distributed power bus for the purpose of powering wholly or in part the probe device.

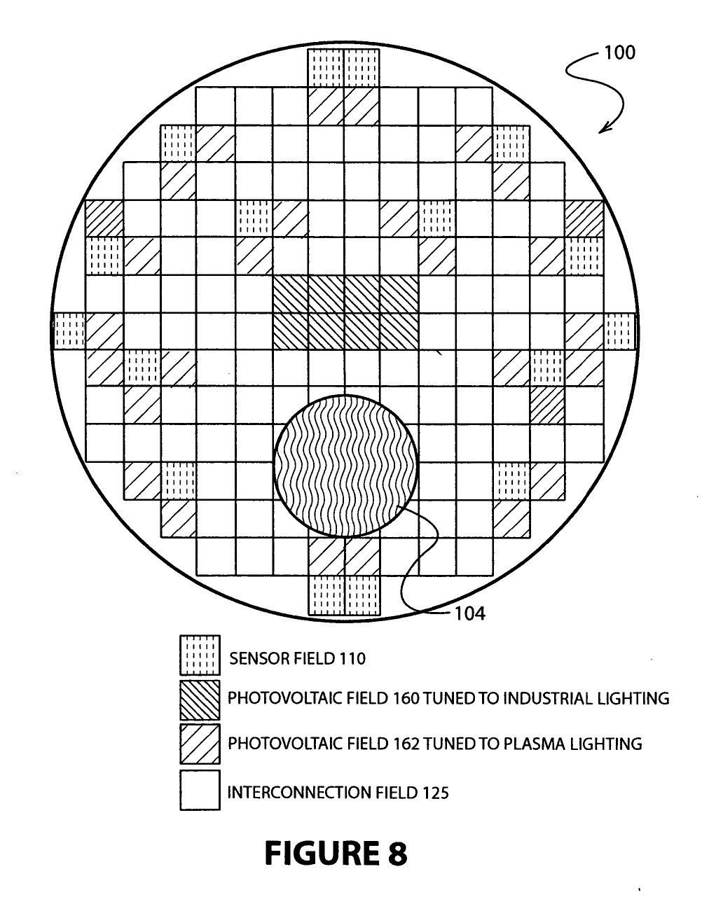

In other embodiments of the invention, photovoltaic cells distributed about a wafer probe provide power locally to sensors, or groups or clusters of sensors that have been spatially patterned across the wafer. FIG. 8 illustrates a wafer-based diagnostic probe comprising photovoltaic power fields 162 disposed by stepped pattern transfer. Photocells of photovoltaic power fields 162 are optimized for collection of photoelectric energy from the photo emission of the plasma in the processing environment. Adjacent to each photovoltaic power field 162 are one or more sensor fields 110 disposed by stepped pattern transfer techniques. Photovoltaic power and sensor fields are field stitched so as to join conductive interconnection pathways of the fields and thereby electrically connect sensors and other elements of sensor fields 110 to the power generating and storage elements of photovoltaic power fields 162. Interconnection between sensors and probe electronics module 104 is provided by field-stitched interconnection fields 125, or alternatively by an overlaid wafer-level interconnection field. By locating photovoltaic power fields 162 in close proximity to power consuming circuits of sensor fields 110, resistive losses and parasitic reactance associated with tightly pitched conductive lines created by lithographic fabrication are reduced. In preferred embodiments, supplemental photovoltaic fields 160 are also provided having photocells optimized for conversion of ambient illumination and interconnected to a power reservoir located within probe electronics module 104 for recharging of the power reservoir during storage periods.

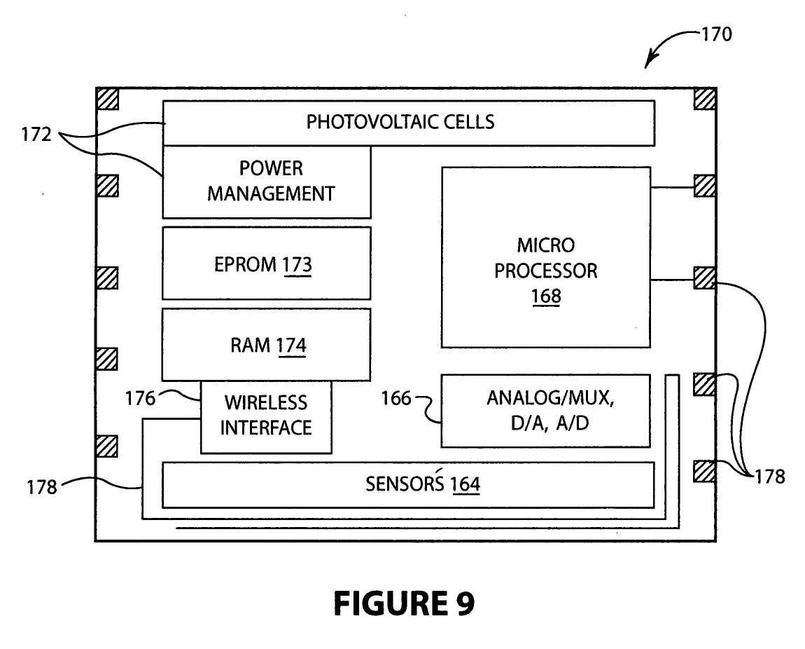

A further embodiment of the invention comprising both sensors and probe electronic elements disposed by pattern transfer techniques is illustrated in FIG. 9. A diagnostic probe comprises integrated sensor system fields 170 disposed by stepped pattern transfer upon the surface of the probe substrate. Integrated system fields 170 comprise one or more sensor fields 164 having sensor circuitry for measuring properties of the plasma processing environment. Integrated system fields 170 further comprise sensor electronics fields 166 interconnected to sensor fields 164. Sensor electronics fields 166 comprise analog-to-digital (A/D) circuitry for converting analog electrical signals generated by sensors of sensor fields 164 to digital form. Sensor electronics fields 166 further comprise digital-to-analog (D/A) circuitry for converting command or control signals sent to the sensors of sensor fields 164 to analog forms required by the sensors. In the event that sensor fields 164 comprise more than one sensor, a multiplexer circuit is also provided in sensor electronics fields 166 for serial sampling of data from the multiple sensors. By providing for transmission of signals to and from sensors of the plasma probe in digital form, the signals can be made more immune to RF noise generated by the plasma environment, thus reducing the number and size of passive RF filtering elements required. Because the A/D and D/A conversions occur in parallel at each sensor, rather than in sequence by a central electronics device, sampling and processing times of sensor data are also improved.

As illustrated in FIG. 9, integrated system field 170 also comprises microprocessor 168, EPROM and RAM memory fields 173 and 174, wireless communication field 176 with antenna 178, and power field 172. Microprocessor 168 controls the operations of the subsystems of system field 170, including sampling of data from sensors of sensor field 164 and storage of data in RAM field 174. EPROM field 173 contains configuration information about the sensor system and/or wafer probe device, as well as instruction sets and/or program commands for microprocessor 168. Wireless communication field 176, together with antenna 178, transmits and receives communications between the wafer-based sensor system and an external transceiver, and may for example be adapted from single-chip wireless system technologies utilized in mobile communication devices and distributed sensing applications. Power field 172 comprises photovoltaic power cells with associated power regulation electronics as exemplified in embodiments of the invention heretofore described. Alternatively, power fields comprise topographically dependent charging devices or other power conversion devices or circuitry disposed by pattern transfer techniques. Interconnections (not shown) among fields are provided as needed, including a common ground connection or conductive plane, as well as local bus connections of power fields to sensors and electronics of the probe device.

Integrated system fields 170 function as Application Specific Integrated Circuit (ASIC) devices that perform high level sensing, computing, data storage, logic, and power management functions, reducing or eliminating need for these electronics in a centralized electronics module or elsewhere on the wafer. In the embodiment illustrated in FIG. 9, each of integrated system fields 170 patterned across the wafer defines a self-contained sensor system capable of performing most or all such functions locally. In other embodiments, portions of the wafer probe functionality, such as computing, power, or communication functions, may be managed centrally. Bonding pads 178 are thus provided for wafer-level interconnection of subsystems of system fields 170 to centralized components of these embodiments.

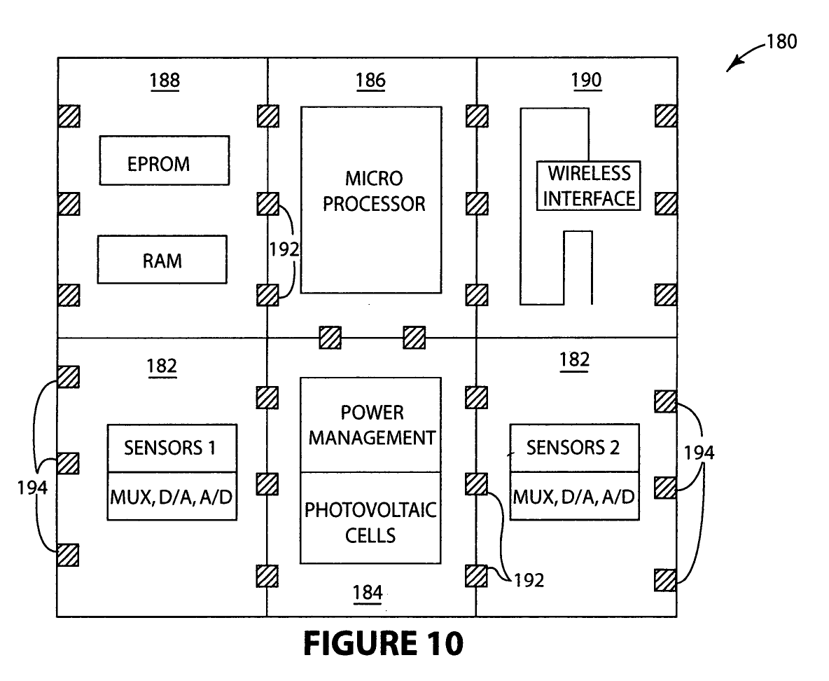

In yet other embodiments, sensor system fields are compartmentalized into separate sensor, power, logic, and communication fields that are interconnected to form complete system fields. Referring to FIG. 10, sensor system fields 180 each comprise subfields including sensor and sensor electronics fields 182, power field 184, microprocessor field 186, memory field 188, and communication field 190. Subfields of sensor system fields 180 are disposed by stepped pattern transfer upon the wafer substrate of a diagnostic probe. Subfields of sensor system fields 180 are field stitched such that bonding pads 192 join and provide electrical interconnectivity. Alternatively, subfields are connected by a wafer-level interconnection overlay or other interconnection means. In this approach, subfields may be modified or customized individually without the need to recreate the mask set for the entire system field. Perimeter bonding pads 194 are provided for interconnection of system fields 180 to other system fields or to wafer-level probe components. Open system fields or subfields having appropriate electrical bonding pads or attachment points may be provided to accommodate additional features such as customized sensors, electronics, or power modules.

The invention includes wafer-based probe devices in which sensor system fields, such as those of the aforementioned embodiment, are interconnected into a wafer-level probe architecture. Alternatively, the sensing and wireless communication functions of system fields operate independently as part of a wafer-based local area network (LAN). In this embodiment, rather than transmitting measurement data through a central communication module, each system field or “die” has the ability to broadcast and receive communications independently. Each die on the wafer is assigned a unique address or other identifier during initialization of the probe device. A base station, either internal or external to the plasma environment, polls each die and receives transmissions of sensor data measured locally to the die, using for example a standard IEEE 802.11 protocol. The individual system fields of the wafer probe thus operate as a sensor network to provide spatially resolved measurements of surface and plasma properties across the wafer surface and throughout the plasma environment.

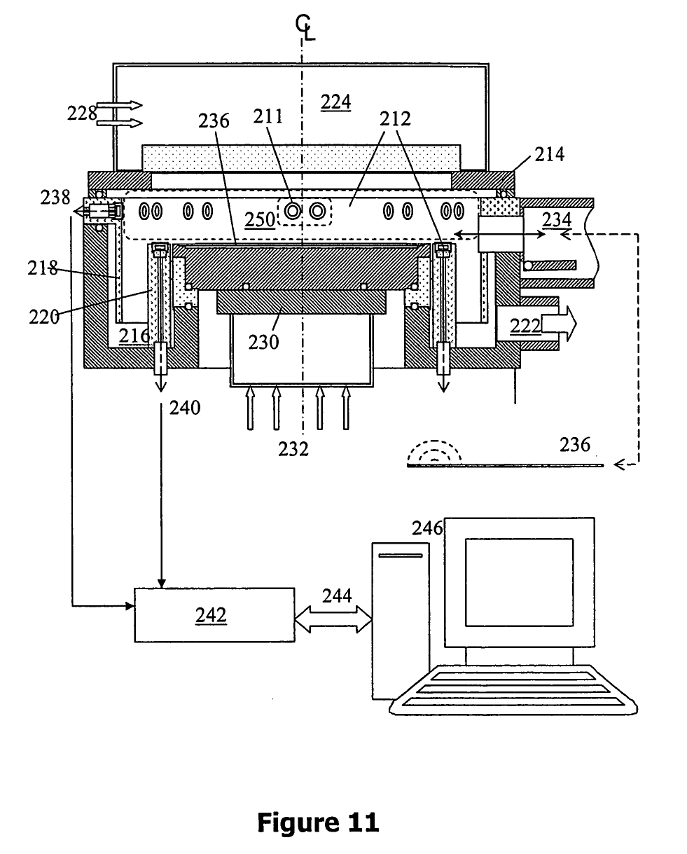

In another application of the invention, sensor system fields disposed upon a wafer subsrate are diced into sensor chips for fixed placement within a plasma processing system. FIG. 11 illustrates one example of a plasma processing system in which diced sensor chips of the invention may be utilized. Processing system 214 comprises a vacuum processing chamber 216, a pumping manifold 222, a plasma source 224 mounted to the top of or in communication with the vacuum chamber 216, a gas delivery manifold or gas shroud (not shown), gas flow, thermal management and power services 228 connecting to the plasma source and system, and a wafer or workpiece chuck or mounting stage 230. The workpiece chuck may include a clamping means, RF power, fluid coolant, lifting pin assembly, and helium backside-thermal conduction facilities 232. A load lock transfer stage with mechanical robotics 234 manipulates and positions a wafer or workpiece 236. Arrays 212 of diagnostic sensors 211 are capable of making real-time measurements of plasma properties about the internal boundaries of a plasma processing system 214. In this particular illustration, two sensor arrays 212 are shown, with one array disposed along the chamber liner 218, and a second array disposed along the dielectric isolation ring 220. Alternatively, sensor arrays may be disposed along a focus ring about the wafer mounting stage 230. Sensors of the apparatus may be used with or without the wafer or workpiece actually present within the processing chamber 216.

The outputs 238 and 240 of the sensor arrays are connected to an external electronic subsystem 242 that houses the stimulating electronics, multiplexer, data acquisition and microprocessor controls for the apparatus. The output 244 of the electronic subsystem 242 is then communicated to a central processor or computer 246. Since the sensor apparatus can be operated during an actual process, the central processor or computer 246 can use the data from the apparatus to monitoring the process conditions and to provide real-time feedback and control signals to various inputs to the plasma processing system. The electronic subsystem 242 may be a separate box, a special micro-electronics add-in card associated with another piece of electronic hardware or computer 248.

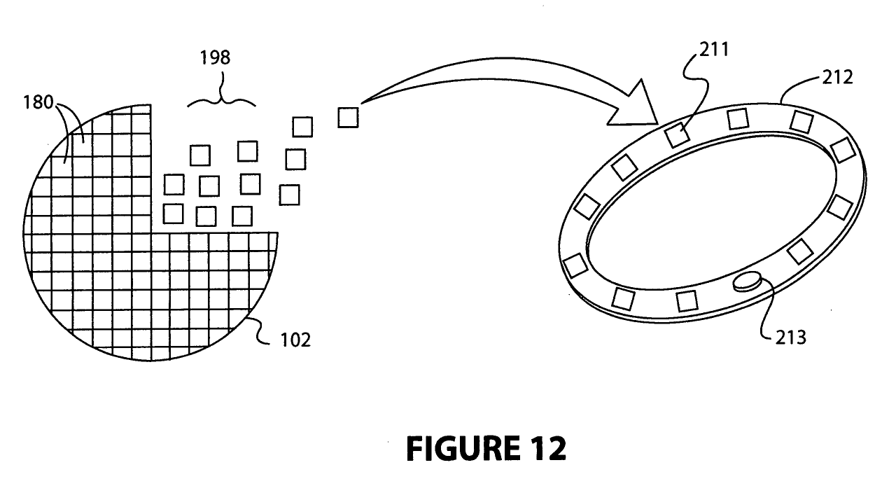

Referring to FIG. 12, a measurement probe comprises sensor system fields 180 disposed by stepped pattern transfer upon the surface of wafer substrate 102. Sensor system fields 180 comprise subfields including, but not limited to, sensor and sensor electronics fields, power fields, microprocessor fields, memory fields, and communication fields. Wafer substrate 102 is diced into sensor system chips 198, each sensor system chip 198 comprising a sensor system field 180. Sensor system chips 198 are disposed as elements 211 of arrays 212 of diagnostic sensors about internal boundaries of a plasma processing system 214 illustrated in FIG. 11. Sensor elements 211 may comprise bonding pads, such as those shown in FIG. 10, for connection of the chips to power, communication, or other diagnostic or control elements of plasma processing system 214. In preferred embodiments, sensor elements 211 are removably affixed to attachment points or receptacles disposed about the processing system so as to be detachable for servicing or replacement.

Diagnostic sensor arrays 212 further comprises an electronics module 213 having communications, power, and processing and control circuitry interconnected to sensor elements 211. Electronics module 213 also comprises a wireless communication interface and processing electronics disposed to operate as a base station for polling and receiving sensor data from a wafer-based diagnostic probe. Undiced wafer-based diagnostic probe 236, configured as a wireless sensor LAN, is introduced into the plasma processing environment as illustrated in FIG. 11, and the sensors, processing, and communication electronics of the probe are activated to collect and transmit data relating to surface or plasma properties to the electronics module 213 base station. In a preferred embodiment, the wireless communication interface of electronics module 213 also communicates wirelessly with electronic subsystem 242 located outside plasma processing system 214. In this embodiment, electronics module 213 interrogates and receives data from wafer-based diagnostic probe 236, then repackages and retransmits the data along with data received from fixed sensor elements 211 to subsystem 242 and computer 246. Electronics module 213 further comprises computational circuitry capable of calibrating sensor elements 211 based upon data received from diagnostic probe 236.

Although there is illustrated and described herein specific structure and details of operation, it is to be understood that these descriptions are exemplary and that alternative embodiments and equivalents may be readily made by those skilled in the art without departing from the spirit and the scope of this invention. Accordingly, the invention is intended to embrace all such alternatives and equivalents that fall within the spirit and scope of the appended claims.

1. A diagnostic plasma measurement probe, comprising:
a) a primary substrate;
b) sensors for measuring properties of a plasma processing environment disposed by stepped pattern transfer upon the primary substrate;
c) electronics for processing sensor measurements disposed upon the primary substrate; and
d) electrical interconnections between the sensors and electronics.

2. The diagnostic plasma measurement probe of claim 1 wherein the sensors comprise at least one temperature diode for measuring a temperature of the probe surface.

3. The diagnostic plasma measurement probe of claim 1 wherein the sensors comprise at least one electrically floating plasma sensor.

4. The diagnostic plasma measurement probe of claim 3 wherein the at least one electrically floating plasma sensor is a dual floating Langmuir probe.

5. The diagnostic plasma measurement probe of claim 1 wherein the sensors comprise at least one electrostatic charge sensor.

6. The diagnostic plasma measurement probe of claim 1 wherein the stepped pattern transfer is a photolithographic process.

7. The diagnostic plasma measurement probe of claim 1 wherein the electrical interconnections are disposed by pattern transfer.

8. The diagnostic plasma measurement probe of claim 7 wherein the electrical interconnections comprise field-stitched interconnection fields disposed by stepped pattern transfer.

9. The diagnostic plasma measurement probe of claim 7 wherein the electrical interconnections comprise an overlaid interconnection field.

10. The diagnostic plasma measurement probe of claim 9 wherein the overlaid interconnection field comprises additional sensors for measuring properties of a plasma processing environment.

11. The diagnostic plasma measurement probe of claim 1 wherein at least a portion of the electronics for processing sensor measurements are disposed by pattern transfer.

12. The diagnostic plasma measurement probe of claim 1, further comprising a wireless communication interface for transmitting sensor measurement data disposed upon the primary substrate.

13. The diagnostic plasma measurement probe of claim 12 wherein the wireless communication interface is disposed by pattern transfer.

14. The diagnostic plasma measurement probe of claim 1, further comprising at least one photovoltaic power cell that provides power for use by the diagnostic plasma measurement probe.

15. The diagnostic plasma measurement probe of claim 14 wherein the at least one photovoltaic power cell is disposed by pattern transfer.

16. The diagnostic plasma measurement probe of claim 14 wherein the at least one photovoltaic power cell is optimized for conversion of radiance from ambient room lighting.

17. The diagnostic plasma measurement probe of claim 14 wherein the at least one photovoltaic power cell is optimized for conversion of radiance from the plasma processing environment.

18. A diagnostic plasma measurement probe, comprising:
a) a primary substrate;
b) system fields disposed by stepped pattern transfer upon the primary substrate, the system fields comprising sensor fields for measuring properties of a plasma processing environment, electronics fields for processing sensor measurements, and electrical interconnections between the sensor fields and electronics fields; and
c) at least one wireless communication interface for transmitting sensor measurement data disposed upon the primary substrate.

19. The diagnostic plasma measurement probe of claim 18 wherein the system fields each comprise a wireless communication interface.

20. The diagnostic plasma measurement probe of claim 18 wherein the system fields further comprise at least one photovoltaic power field.

21. The diagnostic plasma measurement probe of claim 18 wherein the system fields comprise field-stitched sensor fields and electronics fields disposed by stepped pattern transfer.

22. A method of measuring properties of a plasma processing environment comprising the steps of:
a) providing a measurement probe comprising sensors for measuring properties of a plasma processing environment disposed by stepped pattern transfer upon a primary substrate, electronics for processing sensor measurements disposed upon the primary substrate, and electrical interconnections between the sensors and electronics;
b) disposing the measurement probe into a plasma processing system; and
c) collecting data relating to surface or plasma properties in the plasma processing system using the measurement probe.

23. The method of claim 22 wherein the sensors comprise at least one temperature diode for measuring a temperature of the probe surface.

24. The method of claim 22 wherein the sensors comprise at least one electrically floating plasma sensor.

25. The method of claim 22 wherein the electrical interconnections are disposed by pattern transfer.

26. The method of claim 22 wherein at least a portion of the electronics for processing sensor measurements is disposed by pattern transfer.

27. The method of claim 22 wherein the measurement probe further comprises a wireless communication interface for transmitting sensor measurement data.

28. The method of claim 22 wherein the measurement probe further comprises at least one photovoltaic power cell that provides power for use by the measurement probe.

29. A method of measuring properties of a plasma processing environment comprising the steps of:
a) providing a first measurement probe comprising system fields disposed by stepped pattern transfer upon the primary substrate, the system fields comprising sensor fields for measuring properties of a plasma processing environment, electronics fields for processing sensor measurements, and electrical interconnections between the sensor fields and electronics fields;
b) dicing the system fields of the first measurement probe into sensor system chips;
c) disposing the sensor system chips into a sensor array apparatus in a plasma processing system; and
d) collecting first data relating to surface or plasma properties in the plasma processing system using the sensor array apparatus.

30. The method of claim 29 wherein the sensor system chips are removably affixed to attachment points in the sensor array apparatus.

31. The method of claim 29 wherein the system fields further comprise at least one photovoltaic power cell.

32. The method of claim 29 wherein the sensor array apparatus comprises a first wireless communication interface.

33. The method of claim 32, further comprising the steps of:
a) disposing a second measurement probe into a plasma processing system, the second measurement probe comprising sensors for measuring properties of a plasma processing environment and a second wireless communication interface;
b) collecting second data relating to surface or plasma properties in the plasma processing system using the second measurement probe; and
c) transmitting the second data from the second wireless communication interface to the first wireless communication interface.

34. The method of claim 33, further comprising the step of transmitting combined first data and second data outside the plasma processing system using the first wireless communication interface.
